(19) United States
(12) Patent Application Publication
(10) Pub. No.: US 2014/0011598 A1
(43) Pub. Date: Jan. 9, 2014

(54) OVERLOAD PROTECTION TORQUE TRANSMISSION DEVICE

(71) Applicant: Shanghai Kohler Electronics, LTD., Shanghai (CN)

(72) Inventors: Yihua Wang, Shanghai (CN); Xiaojun Zhou, Shanghai (CN)

(21) Appl. No.: 13/935,380

(22) Filed: Jul. 3, 2013

(30) Foreign Application Priority Data
Jul. 5, 2012 (CN) 201220324871.5

(51) Int. Cl. F16D 7/02

(52) U.S. Cl. CPC F16D 7/024
USPC 464/38; 464/45

(57) ABSTRACT

An overload protection transmission device includes a transmission shaft having a mounting element provided at an end thereof, a disc-shaped fixing part rotatably fixed to the transmission shaft via the mounting element, an annular transmission gear, and a locking disc rotatably fixed to the transmission shaft and configured to rotatably couple the transmission shaft with the transmission gear. The transmission gear has an accommodating part and a friction part provided along an inner circumferential surface thereof. The accommodating part is configured to engage the fixing part when the fixing part is inserted into a central opening of the annular transmission gear. The locking disc includes an outer circumferential surface configured to engage the friction part of the transmission gear for transmitting a frictional torque between the locking disc and the transmission gear.

### CROSS-REFERENCE TO RELATED PATENT APPLICATIONS

The present application claims the benefit of and priority to Chinese Patent Application No. 201220324871.5, filed Jul. 5, 2012, under 35 U.S.C. §119. The entirety of Chinese Patent Application No. 201220324871.5 is incorporated by reference herein.

### TECHNICAL FIELD

The present relates generally to mechanical torque transmission devices, and more particularly to an overload protection device for limiting an amount of torque transmitted by a mechanical torque transmission device.

### BACKGROUND

Energy and motion transmission devices have been widely applied in the field of engineering. Typically, a transmission device is connected to a power device and a load. Via the transmission device, power can be transferred to the load. However, if the load is excessive, the transmission device may not be able to drive the load. If an overload protection device is not equipped, this may lead to damaging the transmission device or the power device. Therefore, it is often necessary to design an overload protection device for the transmission device. Overload protection devices are generally configured to cause the transmission device to idle or slip when the load exceeds a threshold value. Thus, overload protection devices can effectively prevent the transmission device or power device from being damaged.

Existing overload protection devices typically include friction surfaces formed respectively on two neighboring parts of the transmission device. Friction between the two friction surfaces is then used to transmit energy or motion (e.g., rotation, torque, etc.) between neighboring transmission parts. With existing overload protection devices, when the external load exceeds the friction threshold, slippage occurs between the friction surfaces, thereby preventing the transmission mechanism from damage caused by an excessive load. However, existing overload protection devices generally include smooth friction surfaces and the generated torque is often susceptible to the influences of temperature, humidity and time. Additionally, the magnitude of the torque transmitted is often difficult to control.

### SUMMARY

An objective of the present invention is to overcome the shortcomings of the prior art and to provide an overload protection transmission device for which the transmitted torque is substantially unaffected by the influences of temperature, humidity and time. Another objective of the present invention is to provide an overload protection transmission device with which the magnitude of the transmitted torque can be more easily controlled.

One implementation of the present disclosure is an overload protection transmission device. The overload protection transmission device includes a transmission shaft, a transmission gear, and a locking disc used for connecting the transmission shaft and the transmission gear. A disc-shaped fixing part may be provided on the transmission shaft and a plurality of first bolt holes may be provided on the fixing part. One end of the transmission shaft (e.g., an end adjacent to the fixing part) may include a mounting part. In some embodiments, the transmission device includes an accommodating part provided on an inner circular surface of the transmission gear. The accommodating part may be used to accommodate the fixing part.

The overload protection transmission device may further include a friction part also provided on the inner circular surface of the transmission gear, a friction surface fitting to the friction part provided on an outer circular surface of the locking disc, and a mounting hole fitting to the mounting part provided at the center of the locking disc. In some embodiments, the overload protection transmission device includes a plurality of second bolt holes corresponding to the first bolt holes provided on the locking disc. The first bolt holes may connect to the second bolt holes via bolts. In some embodiments, the friction part and friction surface are concave and convex surfaces respectively.

In some embodiments, the friction part and the friction surface are provided with uniform continuous wavy arc structures. The arc structures may span an angle between π/60 radians and π/6 radians.

In some embodiments, the friction part and the friction surface are provided with ball-shaped protrusions or bar-shaped ribs.

In some embodiments, an annular step is provided between the accommodating part and the friction part. An inner diameter of the annular step may be smaller than the outer diameter of the fixing part.

In some embodiments, an annular gasket is provided between the fixing part and the locking disc. A plurality of third bolt holes may be provided on the annular gasket. The bolts may pass through the first bolt holes, the second bolt holes, the third bolt holes and may tightly press the annular gasket onto the annular step.

In some embodiments, the mounting part is a spline. The spline may be embedded into the mounting hole. In some embodiments, the friction part and the friction surface are inclined planes. In some embodiments, after assembly of the overload protection transmission device is finished, the assembly is clearance fit between the fixing part and the accommodating part.

In some embodiments, the overload protection transmission device is made from engineering plastics. Before the fixing part is connected to the locking disc, the fixing part and the accommodating part may be interference fitted.

Advantageously, by using the above technical solution, the present invention can realize the several beneficial effects. For example, because the friction part and friction surface may be concave and convex surfaces, the influences of temperature, humidity and time upon the torque generated between the concave and convex surfaces may be relatively small. Additionally, the magnitude of the transmitted torque can be more easily controlled.

### BRIEF DESCRIPTION OF THE DRAWINGS

FIG. 1 is an exploded view drawing of an overload protection transmission device including a transmission shaft, an annular transmission gear, and a locking disc configured to rotatably couple the transmission shaft with the transmission gear, according to an exemplary embodiment.

FIG. 2 is drawing of the overload protection transmission device of FIG. 1 in a compact and assembled form, according to an exemplary embodiment.

FIG. 3 is a cross-sectional drawing of the overload protection transmission device of FIG. 1, illustrating the alignment of an outer circumferential surface of the locking disc with an inner circumferential surface of the transmission gear, according to an exemplary embodiment.

FIG. 4 is a torque versus time graph illustrating the torque transmission performance of a typical torque transmission device having a smooth surface under a high temperature condition, according to an exemplary embodiment.

FIG. 5 is a torque versus time graph illustrating the torque transmission performance of the overload protection transmission device of FIG. 1, illustrating a superior performance under the high temperature condition when compared with a typical torque transmission device, according to an exemplary embodiment.

FIG. 6 is a torque versus time graph illustrating the torque transmission performance of a typical torque transmission device having a smooth surface under a high humidity condition, according to an exemplary embodiment.

FIG. 7 is a torque versus time graph illustrating the torque transmission performance of the overload protection transmission device of FIG. 1, illustrating a superior performance under the high humidity condition when compared with a typical torque transmission device, according to an exemplary embodiment.

### DETAILED DESCRIPTION

Referring generally to the FIGURES, an overload protection transmission device and components thereof are shown according to various exemplary embodiments. Embodiments of the present invention will be further described below in reference to the accompanying drawings.

Referring now to FIGS. 1-3, an overload protection transmission device 100 is shown, according to an exemplary embodiment. Overload protection transmission device 100 is shown to include a transmission shaft 1, a transmission gear 2, and a locking disc 3. Locking disc 3 may be used for connecting transmission shaft 1 with transmission gear 2.

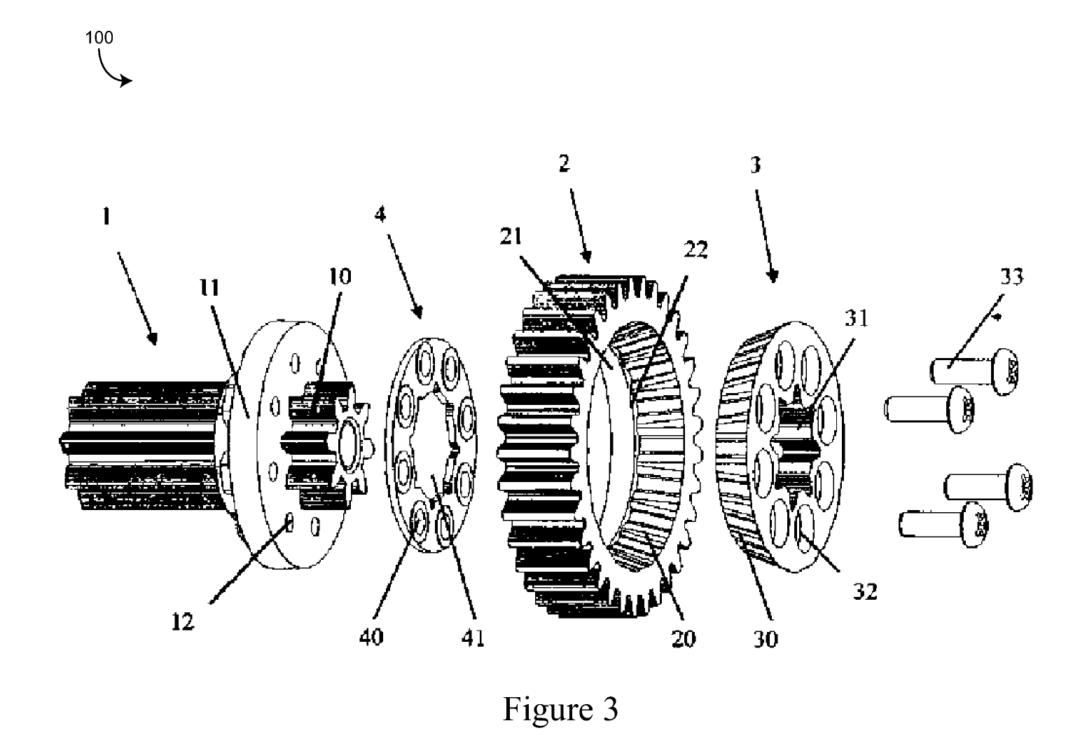

Transmission shaft 1 may be coupled with a fixing part 11. Fixing part 11 may be a disc-shaped part and may be mounted on transmission shaft 1. As shown best in FIG. 3, fixing part 11 may be inserted onto an end of transmission shaft 1 (e.g., such that transmission shaft 1 extends through fixing part 11). The end of transmission shaft 1 onto which fixing part 11 is mounted may function as a mounting part 10. In some embodiments, a plurality of first bolt holes 12 are provided on fixing part 11. Fixing part 11 may be rotatably fixed with transmission shaft 1.

Transmission gear 2 is shown to include an accommodating part 21 and a friction part 20. Accommodating part 21 may be provided along an inner circumferential surface of transmission gear 2 and may be used to accommodate fixing part 11. Friction part 20 may also be provided along an inner circular surface of transmission gear 2 (e.g., adjacent or overlapping with accommodating part 21. Friction part 20 may be configured to align with a friction surface 30 provided along an outer circumferential surface of locking disc 3. In some embodiments, friction part 20 and friction surface 30 are concave and convex surfaces respectively.

Locking disc 3 is shown to include a mounting hole 31 and a plurality of second bolt holes 32. Mounting hole 31 may be a central hole (e.g., provided at the center of locking disc 3) extending partially or completely through locking disc 3. Mounting hole 31 may be configured to fit the size and/or shape of mounting part 10 for rotatably coupling locking disc 3 with transmission shaft 1. Second bolt holes 32 may correspond (e.g., align) with first bolt holes 12 when mounting part 10 is received within mounting hole 31. Bolts 33 may be inserted through second bolt holes 32 and into first bolt holes 12. Bolts 33 may be used to ensure that locking disc 3 remains rotatably fixed relative to fixing part 11.

During assembling, transmission shaft 1 may be inserted into the inner circle of transmission gear 2. Inserting transmission shaft 1 into the inner circle of transmission gear 2 may cause fixing part 11 to be accommodated into accommodating part 21. Then, locking disc 3 may be embedded into the inner circle of transmission gear 2. Embedding locking disc 3 into the inner circle of transmission gear 2 may cause friction surface 30 to contact friction part 20. Mounting part 10 may be inserted into mounting hole 31 on locking disc 3. Finally, bolts 33 may be inserted through the second bolt holes 32 on locking disc 3 and into/through first bolt holes 12 on fixing part 11 to finish the assembly.

Advantageously, the distance between locking disc 3 and fixing part 11 can be adjusted using bolts 33. When the distance between locking disc 3 and fixing part 11 is relatively large, the contact surface (e.g., surface overlap) between friction surface 30 and friction part 20 may be relatively small. Additionally, when the distance between locking disc 3 and fixing part 11 is relatively large, the pressure between friction surface 30 and friction part 20 may be relatively small. Thus, the friction generated between friction surface 30 and friction part 20 may be relatively small when the distance between locking disc 3 and fixing part 11 is relatively large.

When the distance between locking disc 3 and fixing part 11 is relatively small, the contact surface between friction surface 30 and the friction part 20 may be relatively large. Additionally, when the distance between locking disc 3 and fixing part 11 is relatively small, the pressure between friction surface 30 and friction part 20 may be relatively large. Thus, the friction generated between friction surface 30 and friction part 20 may be relatively large when the distance between locking disc 3 and fixing part 11 is relatively small.

When transmission shaft 1 connects to a kinematic power source (e.g., a motor, an electric motor, etc.), transmission shaft 1 may be rotated. The coupling between transmission shaft 1, and locking disc 3 (e.g., via the mounting part 10, via bolts 33, etc.) may cause locking disc 3 to rotate along with transmission shaft 1. Due to the friction generated between friction surface 30 on locking disc 3 and friction part 20 on transmission gear 2, when the external load is within a normal range, such friction can further drive the rotation of the transmission gear 2. However, when the external load exceeds an upper limit (e.g., a known threshold, an unknown limit, etc.), the friction between friction surface 30 and friction part 20 may be insufficient to prevent slippage between transmission gear 2 and locking disc 3. For example, the torque transmitted through transmission shaft 1 may exceed the rotational friction provided between friction part 20 and friction surface 30. Locking disc 3 may then rotate relative to transmission gear 2 without damaging transmission gear 2.

Advantageously, the amount of friction provided between friction part 20 and friction surface 30 (e.g., the friction threshold) can be adjusted via adjusting the bolts 33. This advantage may increase the adaptability and applicability of overload protection transmission device 100 to w wide variety of implementations. For example, the friction threshold can be adjusted in response to a change in the external load or based on the particular implementation to improve the applicability of overload protection transmission device.

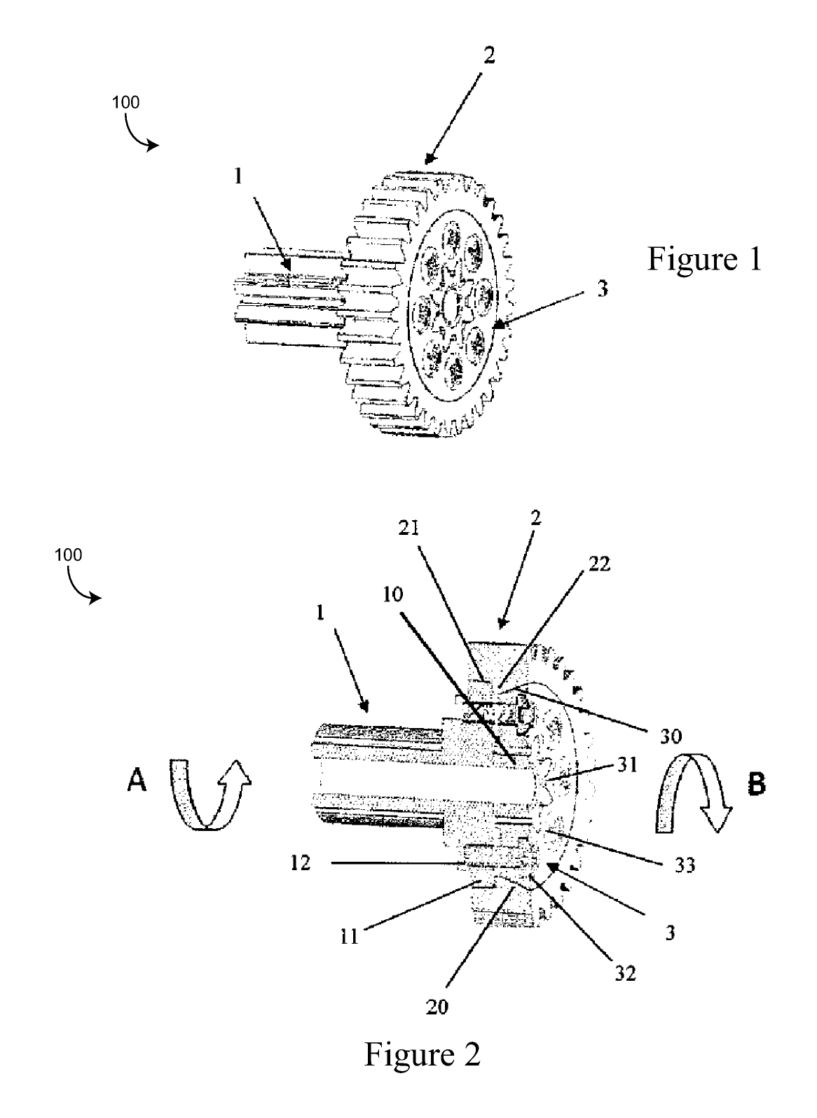

As shown best in FIG. 2, because the fitting surface between friction surface 30 and friction part 20 is located along an outer circumferential surface of locking disc 3, the direction of the friction torque applied to transmission gear 2 may be the same as the direction of rotation of the transmission shaft 1 and transmission gear 2. Therefore the torque generated by transmission shaft 1 may be used as an output, thereby improving transmission efficiency.

For implementations in which friction part 20 and friction surface 30 are concave and convex surfaces, the influences of temperature, humidity, and time on the friction torque between the concave and convex surfaces may be reduced or eliminated. This advantage facilitates improved control over the magnitude of the transmitted torque.

In some embodiments, both friction part 20 and friction surface 30 are provided with uniform continuous wavy arc structures. The angular arc length of the arc structures may range from an arc length of approximately π/60 radians to an arc length of approximately π/6 radians. In some embodiments, the arc length of the arc structures may be approximately π/9 radians. In some embodiments, friction part 20 and friction surface 30 may also be provided with ball-shaped protrusions or bar-shaped ribs.

In some embodiments, friction part 20 and friction surface 30 are inclined planes. For example, in FIG. 2, accommodating part 21 is shown on the left side of the inner circumferential surface of transmission gear 2 and friction part 20 is shown on the right side of the inner circumferential surface of transmission gear 2. The inner diameter of the inclined plane close to accommodating part 21 may be smaller than the inner diameter of the inclined plane far away from accommodating part 21. Advantageously, the use of inclined planes for friction part 20 and friction surface 30 may facilitate gradual insertion of locking disc 3 into friction part 20. In other embodiments, the inner circumferential surfaces of friction part 20 and the friction surface 30 may be flat surfaces as may be desirable for various implementations.

Still referring to FIG. 2, in some embodiments, transmission gear 2 may include an annular step 22. Annular step 22 may be provided between accommodating part 21 and friction part 20. The inner diameter of annular step 22 may be smaller than the outer diameter of fixing part 11 Annular step 22 may be used to position fixing part 11, so as to prevent contact between fixing part 11 and friction surface 30.

In some embodiments, the width of the outer circular surface of the fixing part 11 is identical to the width of the inner circular surface of accommodating part 21. The width of friction part 20 may be identical to the width of friction surface 30. The width of the mounting part 10 may be identical to the width of mounting hole 31. As shown in FIG. 2, when the contact surface between friction part 20 and friction surface 30 is at its maximum, the shape of overload protection transmission device is the most compact and neat. In other embodiments, the above mentioned widths and lengths are not necessarily identical, which can also meet the requirement of overload protection and transmission.

In some embodiments, mounting part 10 functions as a spline to rotatably couple transmission shaft 1 and locking disc 3. For example, mounting part 10 can be embedded into mounting hole 31. The spline-shaped mounting part 10 may be configured to fit into the mounting hole 31, and the shape of mounting hole 31 may correspond to that of the mounting part 10. Mounting part 10 can be inserted into mounting hole 31 and can be used to drive locking disc 3 to rotate along with transmission shaft 1 along a central axis of transmission shaft 1. The mounting part 10 can also be in other shapes, as long as it can play the role of driving the locking disc 3.

Referring specifically to FIG. 3, in some embodiments, overload protection transmission device includes an annular gasket 4. Annular gasket 4 may be provided between fixing part 11 and locking disc 3 Annular gasket 4 is shown to include a plurality of third bolt holes 40 and a central hole 41. Third bolt holes 40 may extend through annular gasket 4 and may be configured to receive bolts 33. In some embodiments, third bolt holes 40 align with first bolt holes 12 and second bolt holes 32 such that bolts 33 pass through second bolt holes 32, third bolt holes 40, and first bolt holes 12 (in that order). Tightening bolts 33 may tightly press annular gasket 4 onto annular step 22.

Central hole 41 may extend centrally through annular gasket 4 and may be sized and/or shaped to allow transmission shaft 1 to pass therethrough. In some embodiments, central hole 41 is configured to engage transmission shaft 1 Annular gasket 4 may be inserted into mounting part 10 between fixing part 11 and locking disc 3 such that one side of annular gasket 4 tightly contacts fixing part 11 and the other side of annular gasket 4 tightly contacts annular step 22. Annular gasket 4 may be during assembly of overload protection transmission device 100. For example, prior to transmission shaft 1 being inserted into the inner circle of transmission gear 2, annular gasket may be inserted onto mounting part 10 of transmission shaft 1.

In some embodiments, after assembly of overload protection transmission device 100 is finished, there is a clearance fit between fixing part 11 and accommodating part 21. In some embodiments, a small gap may be maintained between fixing part 11 and accommodating part 21. In other embodiments, a contact fitting is used such that no gap between fixing part 11 and accommodating part 21 is maintained. The small size of the gap (if any) may prevent transmission gear 2 from moving radially relative to transmission shaft 1.

In some embodiments, overload protection transmission device 100 is made from engineering plastics. Because engineering plastics may have a certain level of elasticity, locking disc 3 may prop against transmission gear 2 and cause transmission gear 2 to expand outward when fixing part 11 is connected to locking disc 3 (e.g., upon inserting locking disc 3 into the inner circle of transmission gear 2).

In some embodiments, an interference fit may be used between fixing part 11 and accommodating part 21. Fixing part 11 and accommodating part 21 may be interference fit during assembly (e.g., before fixing part 11 is connected to locking disc 3, when transmission shaft 1 is being inserted into the inner circle of transmission gear 2). Any outward expansion of transmission gear 2 (e.g., due to material elasticity) may cause the interference fit between fixing part 11 and accommodating part 21 to disappear. If prior to the connection, there is already a clearance fit between fixing part 11 and accommodating part 21, the gap between fixing part 11 and accommodating part 21 may be overly large and may allow transmission gear 2 to move radially relative to transmission shaft 1. Advantageously, the interference fit between fixing part 11 and accommodating part 21 may be used to compensate for the outward expansion of transmission gear 2 such that the desired tolerances are maintained.

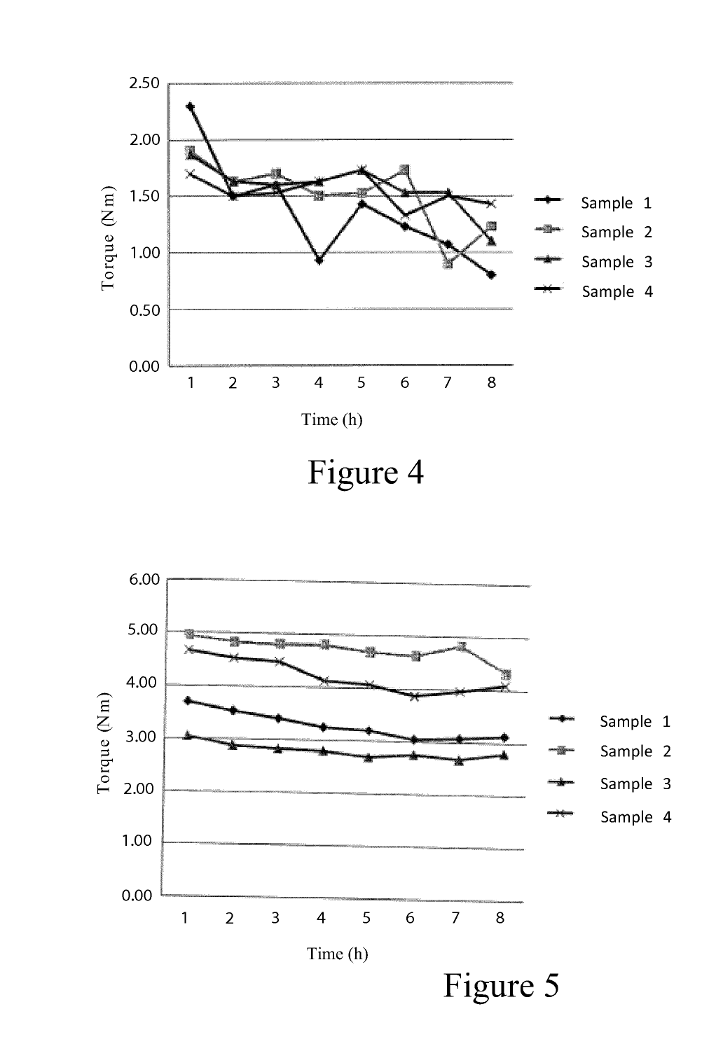

Referring now to FIGS. 4-5, two graphs illustrating an advantage provided by the use of concave and convex surfaces for friction part 20 and friction surface 30 are shown, according to an exemplary embodiment. FIGS. 4-5 illustrate performance under a high temperature condition of approximately 70° C. FIG. 4 is a torque versus time graph illustrating the output torque provided by traditional smooth friction surfaces. FIG. 5 is a torque versus time graph illustrating the improved torque performance provided by the concave and convex surfaces of friction part 20 and friction surface 30. Advantageously, the concave and convex surfaces embodied in friction part 20 and friction surface 30 allow the output torque to be controlled more evenly and consistently when compared with traditional smooth friction surfaces when implemented in relatively high temperature conditions.

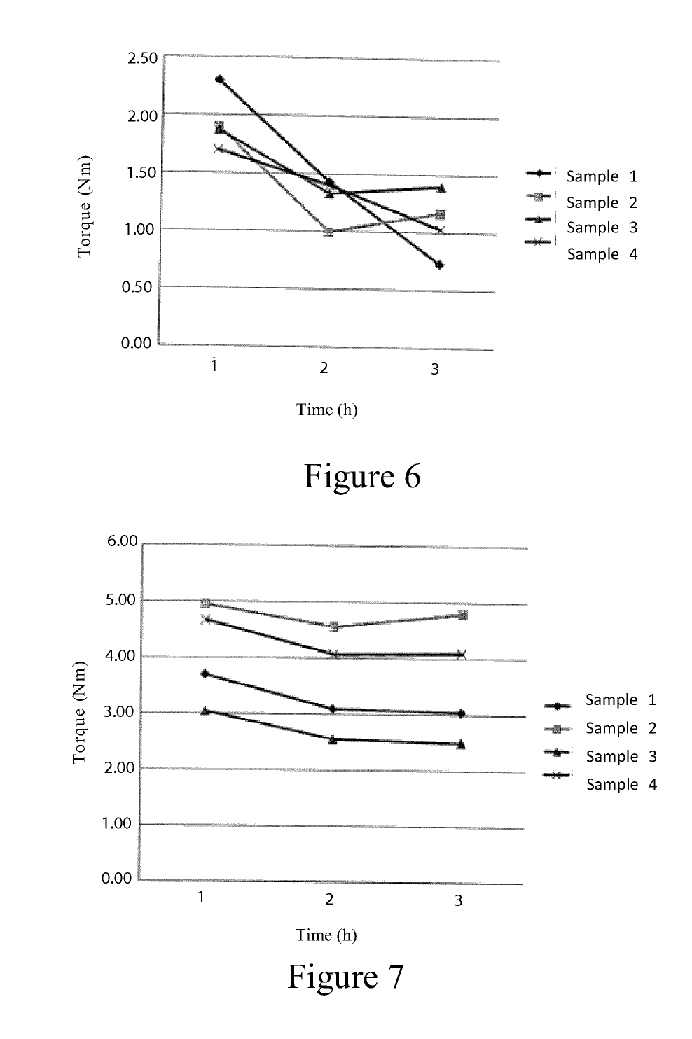

Referring now to FIGS. 6-7, two graphs illustrating another advantage provided by the use of concave and convex surfaces for friction part 20 and friction surface 30 are shown, according to an exemplary embodiment. FIGS. 6-7 illustrate performance under a high humidity condition (e.g., a temperature of approximately 40° C., 95% relative humidity) with several of the components of overload protection transmission device 100 made from engineering plastics having a certain elasticity and relatively low water absorption rates. FIG. 6 is a torque versus time graph illustrating the output torque provided by traditional smooth friction surfaces. FIG. 7 is a torque versus time graph illustrating the improved torque performance provided by the concave and convex surfaces of friction part 20 and friction surface 30.

Advantageously, the concave and convex surfaces of in friction part 20 and friction surface 30 (e.g., with or without wavy arc structures) may allow the magnitude of the torque generated between friction part 20 and friction surface 30 to be better controlled. This advantage may reduce or eliminate the influences of temperature, humidity, and time on the output torque. This advantage may also reduce the required tightening force for bolts 33 and may allow fewer bolts 33 to be used.

What is claimed is:

1. An overload protection transmission device comprising:
a transmission shaft having a mounting element provided at an end thereof;
a disc-shaped fixing part rotatably fixed to the transmission shaft via the mounting element;
an annular transmission gear having an inner circumferential surface, an accommodating part provided along the inner circumferential surface, and a friction part provided along the inner circumferential surface adjacent to the accommodating part, wherein the accommodating part is configured to engage the fixing part when the fixing part is inserted into a central opening of the annular transmission gear; and
a locking disc rotatably fixed to the transmission shaft and configured to rotatably couple the transmission shaft with the transmission gear, wherein an outer circumferential surface of the locking disc is a friction surface configured to engage the friction part of the transmission gear for transmitting a frictional torque between the locking disc and the transmission gear.

2. The overload protection transmission device of claim 1, wherein the disc-shaped fixing part includes a plurality of first bolt holes along a planar face thereof;
wherein the locking disc includes a plurality of second bolt holes configured to align with the first bolt holes;
wherein the locking disc is rotatably fixed to the disc-shaped fixing part via a plurality of bolts inserted into the first and second bolt holes.

3. The overload protection transmission device of claim 2, further comprising:
an annular gasket positioned between the disc-shaped fixing part and the locking disc, wherein the gasket includes a plurality of third bolt holes configured to align with the first and second bolt holes;
wherein the plurality of bolts extend through the third bolt holes.

4. The overload protection transmission device of claim 1, wherein the locking disc includes a mounting hole extending at least partially through the locking disc along a rotational axis thereof, wherein the mounting hole is configured to receive the mounting element of the transmission shaft;
wherein the locking disc is rotatably fixed to the transmission shaft via a connection between the mounting element and the mounting hole.

5. The overload protection transmission device of claim 1, wherein the friction part of the annular transmission gear includes one of a concave surface and a convex surface;
wherein the friction surface of the locking disc includes the other of the concave surface and the convex surface;
wherein the concave and convex surfaces are configured to at least partially align when the locking disc is inserted into the central opening of the annular transmission gear;
wherein the frictional torque is transmitted from the locking disc to the transmission gear along the aligned portion of the concave and convex surfaces.

6. The overload protection transmission device of claim 1, wherein the friction part of the annular transmission gear and the friction surface of the locking disc include one or more uniform continuous arc structures.

7. The overload protection transmission device of claim 6, wherein the uniform continuous arc structures have a curvature ranging from approximately π/60 radians to approximately π/6 radians.

8. The overload protection transmission device of claim 1, wherein the friction part of the annular transmission gear and the friction surface of the locking disc include at least one of ball-shaped protrusions or bar-shaped ribs.

9. The overload protection transmission device of claim 1, further comprising:
an annular step provided along the inner circumferential face of the annular transmission gear between the accommodating part and the friction part, wherein the annular step has an inner diameter smaller than the outer diameter of the fixing part, wherein the annular step is configured to position the fixing part relative to the annular transmission gear.

10. The overload protection transmission device of claim 1, wherein the disc-shaped fixing part has an outer diameter larger than the diameter of the inner circumferential surface of the annular transmission gear;
wherein the fixing part is interference fit into the central opening of the annular transmission gear.

11. The overload protection transmission device of claim 10, wherein the annular transmission gear is configured to expand outward when the locking disc is inserted into the central opening thereof;
wherein interference fit between the fixing part and the transmission gear is configured to transform into a clearance fit as a result of the outward expansion of the annular transmission gear.

12. An overload protection transmission device comprising:
a transmission shaft having a spline provided at an end thereof;
an annular transmission gear having a first inner circumferential surface and a second inner circumferential surface adjacent to the first inner circumferential surface, wherein the first inner circumferential surface is configured to fix a position of the transmission shaft relative to the transmission gear when the transmission shaft is inserted into a central opening of the annular transmission gear; and
a locking disc rotatably fixed to the transmission shaft and configured to rotatably couple the transmission shaft with the transmission gear, wherein an outer circumferential surface of the locking disc is configured to engage the second inner circumferential surface of the transmission gear, wherein the locking disc is configured to transmit a frictional torque between the outer circumferential surface of the locking disc and the second inner circumferential surface of the transmission gear.

13. The overload protection transmission device of claim 12, wherein the locking disc includes a mounting hole extending at least partially through the locking disc along a rotational axis thereof, wherein the mounting hole is configured to receive the transmission shaft spline;
wherein the locking disc is rotatably fixed to the transmission shaft via a connection between the spline and the mounting hole.

14. The overload protection transmission device of claim 12, further comprising:
a disc-shaped fixing part rotatably fixed to the transmission shaft via the spline, wherein an outer circumferential surface of the fixing part is configured to engage the first inner circumferential surface of the annular transmission gear for fixing the position of the transmission shaft relative to the transmission gear.

15. The overload protection transmission device of claim 14, further comprising:
an annular step extending between the first inner circumferential surface and the second inner circumferential surface of the transmission gear, wherein the annular step is configured to position the disc-shaped fixing part relative to the transmission gear.

16. The overload protection transmission device of claim 15, further comprising:
an annular gasket positioned between the disc-shaped fixing part and the locking disc, wherein the annular gasket is configured to engage the annular step.

17. The overload protection transmission device of claim 12, wherein the disc-shaped fixing part includes a plurality of first bolt holes along a planar face thereof;
wherein the locking disc includes a plurality of second bolt holes configured to align with the first bolt holes;
wherein the locking disc is rotatably fixed to the disc-shaped fixing part via a plurality of bolts inserted into the first and second bolt holes.

18. The overload protection transmission device of claim 12, wherein the locking disc is movable relative to the transmission gear along an axis of rotation thereof, wherein movement of the locking disc relative to the transmission gear along the axis of rotation adjusts a size of a contact surface between the locking disc and the transmission gear;
wherein adjusting the size of the contact surface alters an amount of frictional torque transmitted between the locking gear and the transmission gear.

19. The overload protection transmission device of claim 18, wherein movement of the locking disc relative to the transmission gear along the axis of rotation adjusts a pressure between the locking disc and the transmission gear;
wherein adjusting the pressure between the locking disc and the transmission gear alters an amount of frictional torque transmitted between the locking gear and the transmission gear.

20. An overload protection transmission device comprising:
a transmission shaft;
an annular transmission gear having a concave inner circumferential surface; and
a locking disc fixed to the transmission shaft and configured to rotatably couple the transmission shaft with the transmission gear, wherein the locking disc includes a convex outer circumferential surface configured to engage the concave circumferential surface of the annular transmission gear, wherein the locking disc is configured to transmit a frictional torque between the outer circumferential surface of the locking disc and the inner circumferential surface of the transmission gear.
